(19) United States
(12) Patent Application Publication
(10) Pub. No.: US 2012/0216899 A1
(43) Pub. Date: Aug. 30, 2012

(54) Piggable Static Mixer Apparatus and System for Generating a Hydrate Slurry

(76) Inventors: Chad A. Broussard, Scott, LA (US); Tracy A. FOWLER, Sugar Land, TX (US); Donald P. SHATTO, Houston, TX (US); Douglas J. TURNER, Humble, TX (US); Larry D. TALLEY, Friendswood, TX (US); Jason LACHANCE, Pearland, TX (US); David GREAVIS, Centennial, CO (US)

(21) Appl. No.: 13/464,573

(22) Filed: May 4, 2012

Related U.S. Application Data
(63) Continuation-in-part of application No. 12/162,477, filed on Jul. 28, 2008.

(51) Int. Cl. B01F 5/00; B01F 15/06; B01F 5/06

(52) U.S. Cl. 137/896; 366/336; 366/144

(57) ABSTRACT

Provided are piggable static mixers, apparatus for generating a non-plugging hydrate slurry, systems incorporating the same, and methods of using the same. Piggable static mixers include an inlet orifice, an outlet orifice in fluid communication with the inlet orifice, and a mechanism fluidly coupled between the inlet and outlet orifices. The mechanism is configurable between a first state and a second state. Fluid flow between the inlet and outlet orifices is substantially unimpeded when the mechanism is in the first state. A static mixer element impinges upon the fluid flow when the mechanism is in the second state. The system further includes a production facility and a production line. The system and methods provided are useful for production of wellstream hydrocarbons from subsea and arctic environments.

### CROSS REFERENCE TO RELATED APPLICATIONS

This application is a continuation-in-part of U.S. application Ser. No. 12/162,477, filed Feb. 22, 2007, which claims priority to U.S. provisional application 60/782,449, filed Mar. 15, 2006, and U.S. provisional application 60/899,000, filed Feb. 2, 2007, and is a continuation of U.S. application PCT/US2010/053328, filed Oct. 20, 2010, which claims priority to U.S. provisional application 61/262,371, filed Nov. 18, 2009, and U.S. provisional application 61/393,199, filed Oct. 14, 2010, all of which are herein incorporated by reference in their entirety. This application is related to U.S. patent application Ser. No. 12/162,479, filed Feb. 13, 2007, which is herein incorporated by reference in its entirety.

### TECHNOLOGY FIELD

This disclosure relates generally to static mixers, apparatus for generating a hydrate slurry, systems incorporating the same, and methods of using the same. More particularly, this disclosure relates to piggable apparatus and systems for reducing loss of flow due to hydrate solids deposits in a pipeline.

### BACKGROUND

This section introduces various aspects of the art, which may be associated with exemplary embodiments of the presently disclosed invention. This discussion may assist in providing a framework to facilitate a better understanding of particular aspects of the present disclosure. Accordingly, it should be understood that this section should be read in this light, and not necessarily as admissions of prior art.

A natural gas hydrate is an ice-like compound consisting of light hydrocarbon molecules encapsulated in an otherwise unstable water crystal structure. These hydrates form at high pressures and low temperatures where a suitable mixture of hydrocarbons and water are present. Such conditions are prevalent in “cold-flow” pipelines, where the pipeline and wellstream fluids are unheated, and the wellstream fluids are allowed to flow through the pipeline at the low ambient temperatures often found in subsea or arctic environments. Cold-flow delivery of wellstream fluids is highly desirable since it avoids the cost of insulating the pipeline and heating the pipeline and the contained fluids. Unfortunately, undesirable wax like deposits (“wax”) and/or scale deposits may form in the pipeline; especially when the produced fluids naturally contain wax compounds such as paraffin. Buildup of these deposits may cause a blockage in the pipeline; necessitating costly and time-consuming procedures to re-establish flow.

One of the most common mitigating strategies for buildup, such as wax and/or scale, is to periodically launch an object, commonly referred to as a “pig”, through the process pipeline to scrape the buildup from the walls. In addition, a pig may be used in connection with various other advantageous techniques known in the art such as chemical dosing, corrosion surveillance, and/or the like. As such, the use of a pig in connection with a cold-flow pipeline may be desirable.

Various conventional subsea processes exist, such as described in U.S. Pat. Pub. No. 2006/0175063, which describes a system for subsea hydrocarbon production flow in pipelines. The system chills a hydrocarbon production flow in a heat exchanger thereby causing solids to form, and then periodically removing deposits and placing them in a slurry utilizing a closed loop pig launching and receiving system.

Another conventional subsea process is taught in Patent Cooperation Treaty publication no. WO 00/25062, which describes a method for transporting a flow of fluid hydrocarbons containing water through a treatment and transportation system. The system introduces a flow of fluid hydrocarbons and particles of gas hydrates into a reactor.

However, conventional subsea processes often include additional sections of pipe around the mixer(s). Such “bypass” sections add to the cost and complexity of the pipeline. In addition, certain sections of the pipeline, such as those sections directly adjacent each static mixer would remain un-piggable.

Thus, there is a need for an improved static mixer apparatus design and related systems, which facilitate the pigging of a pipeline without one or more of the drawbacks associated with the inclusion of bypass sections.

### SUMMARY

Provided are piggable static mixer apparatus, apparatus for generating a hydrate slurry, systems incorporating the same, and methods of using the same. In at least one exemplary embodiment, the static mixer apparatus includes an inlet orifice, an outlet orifice in fluid communication with the inlet orifice, and a mechanism fluidly coupled between the inlet and outlet orifices. The mechanism is generally configurable between a first state and a second state. Fluid flow between the inlet and outlet orifices is generally substantially unimpeded when the mechanism is in the first state and a static mixer element generally impinges upon the fluid flow when the mechanism is in the second state.

Also provided are systems for selectively impinging a static mixer element upon a fluid flow. The systems may include a production facility, a production line, and a static mixer apparatus fluidly coupled in-line with the production line. The static mixer apparatus includes an inlet orifice, an outlet orifice in fluid communication with the inlet orifice, and a mechanism fluidly coupled between the inlet and outlet orifices. The mechanism may be configurable between a first state and a second state. Fluid flow between the inlet and outlet orifices is generally substantially unimpeded when the mechanism is in the first state and a static mixer element generally impinges upon the fluid flow when the mechanism is in the second state.

Piggable static mixers are useful in any pipeline that will be pigged, such as pipelines: (a) transporting hydrocarbon streams susceptible to buildup of wax, hydrates, scale, or combinations thereof, (b) transporting hydrocarbon streams requiring chemical dosing, or (c) which are examined for corrosion surveillance. The provided systems and methods for generating a hydrate slurry are useful for production of wellstream hydrocarbons from subsea and arctic environments.

### BRIEF DESCRIPTION OF THE FIGURES

The present invention is further described in the detailed description which follows, in reference to the noted plurality of drawings by way of non-limiting examples of embodiments of the present invention, in which like reference numerals represent similar parts throughout the several views of the drawings, and wherein:

FIGS. 1A-1B are cut-away illustrations of a static mixer apparatus in a first and second state in accordance with a first embodiment of the present invention;

FIGS. 2A-2B are cut-away illustrations of a static mixer apparatus in a first and second state in accordance with a second embodiment of the present invention;

FIGS. 3A-3B are cut-away illustrations of a static mixer apparatus in a first and second state in accordance with a third embodiment of the present invention;

FIGS. 4A-4B are cut-away illustrations of a static mixer apparatus in a first and second state in accordance with a fourth embodiment of the present invention;

FIGS. 5A-5B are cut-away illustrations of a static mixer apparatus in a first and second state in accordance with a fifth embodiment of the present invention; and

FIG. 6A illustrates an exemplary system having a static mixer in a main pipeline.

FIG. 6B illustrates exemplary system having a staged side stream having a primary reactor and a secondary reactor.

FIG. 7 is an illustration of an exemplary system for generating and recovering subsea dry hydrates using static mixers in accordance with embodiments of the present invention.

### DETAILED DESCRIPTION

In the following detailed description, specific embodiments of the disclosure are described in connection with preferred embodiments. However, to the extent that the following description is specific to a particular embodiment or a particular use of the present techniques, it is intended to be illustrative only and merely provides a concise description of the exemplary embodiments. Accordingly, the invention is not limited to the specific embodiments described below, but rather; the invention includes all alternatives, modifications, and equivalents falling within the true scope of the appended claims.

### DEFINITIONS

As used herein, the “a” or “an” entity refers to one or more of that entity. As such, the terms “a” (or “an”), “one or more”, and “at least one” can be used interchangeably herein unless a limit is specifically stated.

As used herein, the terms “comprising,” “comprises,” “comprised,” and “comprise” are open-ended transition terms used to transition from a subject recited before the term to one or elements recited after the term, where the element or elements listed after the transition term are not necessarily the only elements that make up of the subject.

As used herein, the terms “containing,” “contains,” and “contain” have the same open-ended meaning as “comprising,” “comprises,” and “comprise.”

As used herein, the term “production facility” refers to one or more structure(s) for carrying out activities on an inlet and/or an outlet of a production line. The production facility may be a floating vessel located over or near a subsea production well such as an FPSO (floating, production, storage and offloading vessel), an offshore fixed structure platform with production capabilities, an onshore structure with production capabilities and/or the like.

As used herein, the term “production line” may be a pipeline or other conduit for transporting wellstream fluid to a production facility.

As used herein, the term “production well” may refer to a well that is drilled into a reservoir and used to recover a hydrocarbon material.

As used herein, the terms “having,” “has,” and “have” have the same open-ended meaning as “comprising,” “comprises,” and “comprise.”

As used herein, the terms “including,” “includes,” and “include” have the same open-ended meaning as “comprising,” “comprises,” and “comprise.”

As used herein, the term “static mixer” may refer to an apparatus for (i) mixing a liquid and/or gas, and/or (ii) reducing the droplet size of a liquid and/or gas; wherein the mixing is not accomplished through motion of the apparatus but rather the motion of the liquid and/or gas facilitates the mixing.

As used herein, the term “wellstream fluid” may be a liquid and/or gas, such as hydrocarbon material, recovered from a production well.

### DESCRIPTION

Provided are piggable static mixer apparatus, apparatus for generating a hydrate slurry, systems incorporating the same, and methods of using the same. Embodiments of static mixers provided herein facilitate the pigging of a pipeline without one or more of the drawbacks associated with the inclusion of bypass sections.

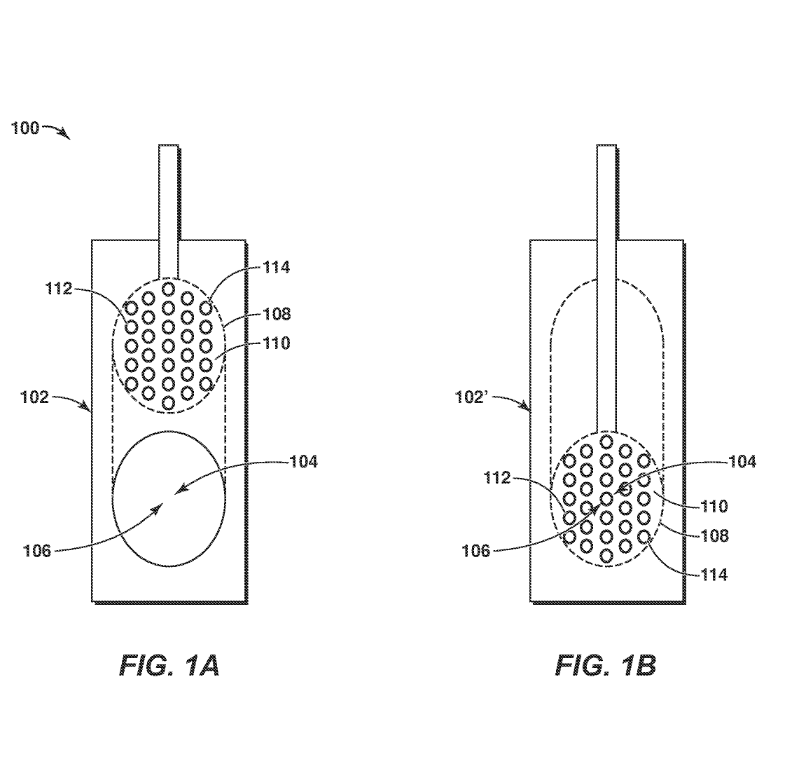

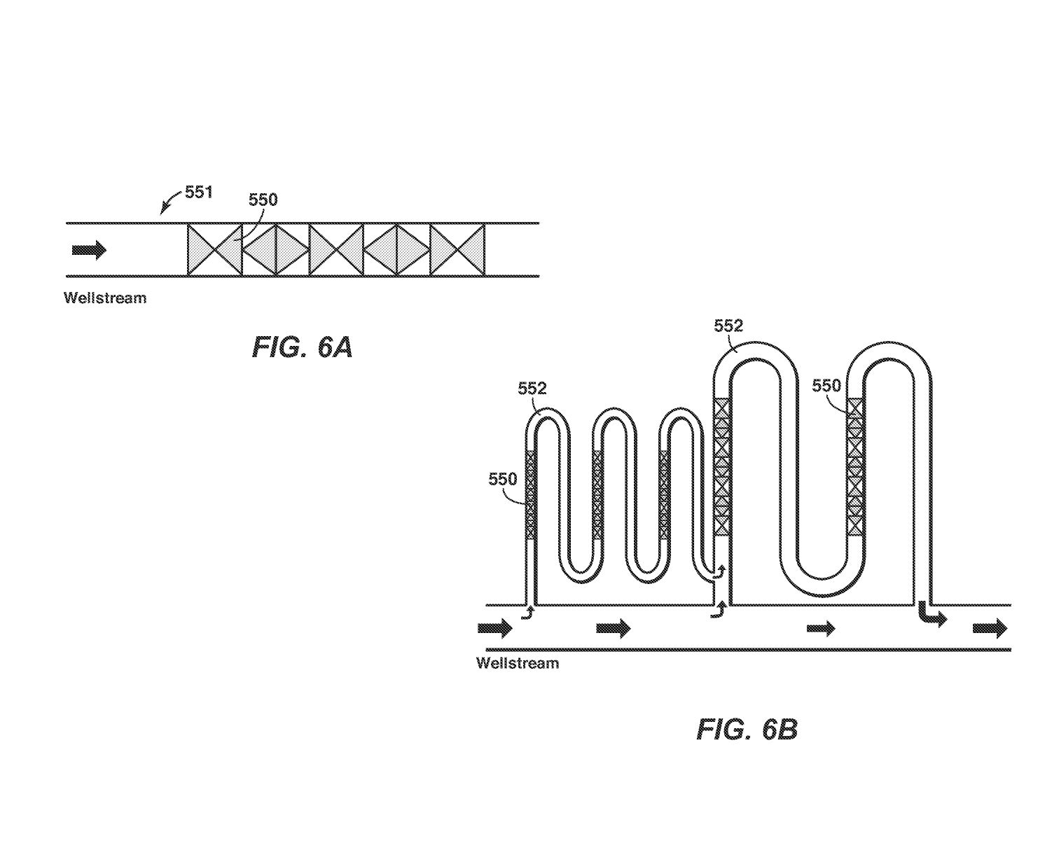

Referring now to FIGS. 1A and 1B, cut-away illustrations are provided of a static mixer apparatus 100 in both a first 102 and second state 102′ in accordance with a first embodiment of the present invention. In general, the apparatus 100 comprises an inlet orifice 104 and an outlet orifice 106 in fluid communication with one another. A mechanism 108 is fluidly coupled between the inlet 104 and outlet 106 orifices. The mechanism 108 includes a retractable plate 110 which may include a plurality of holes 112. In at least one embodiment the holes 112, themselves, act to mix wellstream fluid passing there through to enhance formation of dry hydrates (i.e., the holes 112 themselves act as static mixers) in a cold-flow application, such as the application described in connection with FIG. 6 (below). In yet another embodiment, each hole 112 includes a static mixer 114 for mixing of wellstream fluid passing there through. While a single grouping of holes 112 is shown in FIGS. 1A and 1B, one or more embodiments of the present invention may implement a plurality of groups of holes 112 and/or static mixers 114 arranged in any appropriate pattern to meet the design criteria of a particular application.

When the apparatus 100 is in the first state 102 the plate 110 is substantially extracted (i.e., removed) from the fluid flow such that the fluid flow between the inlet 104 and outlet 106 orifices is substantially unimpeded. In contrast, when the apparatus 100 is in the second state 102′, the plate 110 is inserted into the fluid flow such that the static mixer element (e.g., holes 112 and/or static mixers 114) impinges upon the fluid flow. While a single plate 110 is shown in FIGS. 1A and 1B, any suitable number and configuration of plates 110 may be implemented to satisfy the design criteria of a particular application. For example, one or more embodiments may implement a plurality of plates 110 in series (i.e., stacked one above the other) and/or in parallel (i.e., stacked side by side). Furthermore, one or more of the plurality of plates 110 may include a unique (i.e., different as compared to the other plates 110) number of holes 112 and/or static mixers 114.

It may be appreciated, then, that a pig or other object may be passed substantially unimpeded through the apparatus 100 when the apparatus 100 (and therefore the mechanism 108) is configured in the first state 102. Likewise, the apparatus 100 may be placed in the second state 102′ when it is desirable to enhance mixing, formation of dry hydrates and/or emulsions (e.g., via the static mixer element) in a cold-flow application, and/or the like.

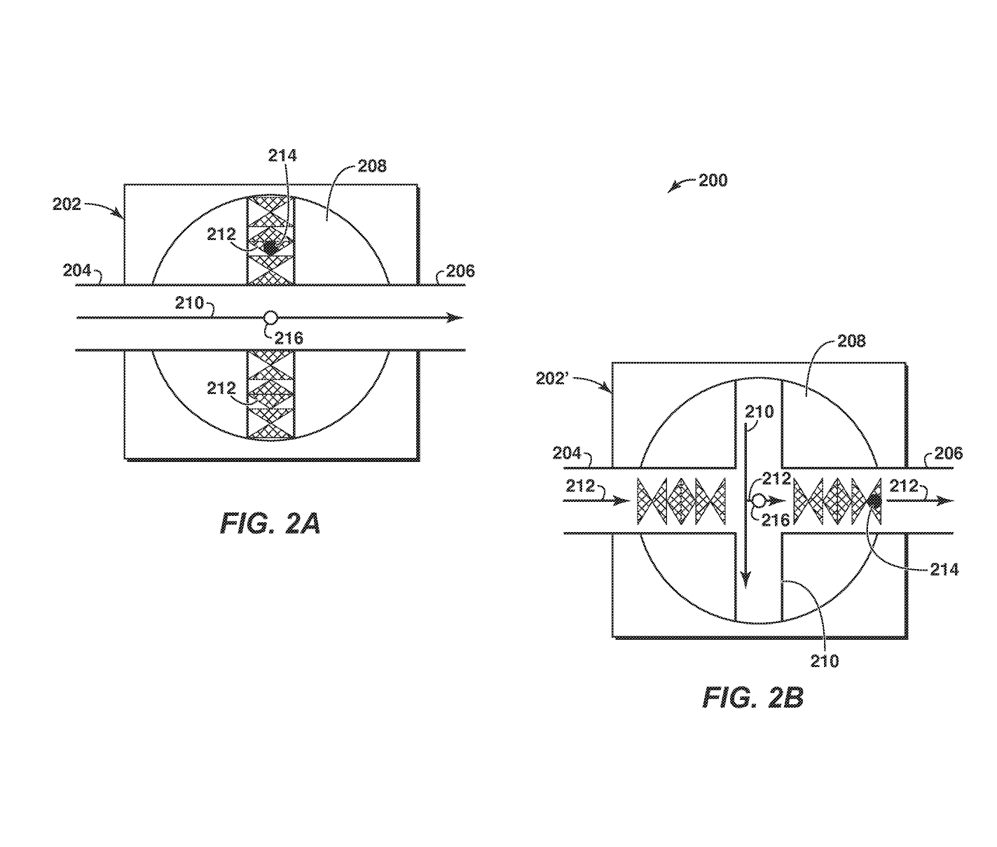

With reference to FIGS. 2A and 2B, cut-away illustrations are provided of a static mixer apparatus 200 in both a first 202 and second state 202′ in accordance with a second embodiment of the present invention. In general, the static mixer apparatus 200 comprises an inlet orifice 204 and an outlet orifice 206 in fluid communication with one another. A mechanism 208 is fluidly coupled between the inlet 204 and outlet 206 orifices. The mechanism 208 includes a first channel 210 (preferably substantially devoid of obstructions) and a second channel 212 having one or more static mixer elements 214. In general the mechanism 208 rotates (clockwise and/or counterclockwise) on an axis 216 for selectively aligning (i.e., fluidly coupling) either the first 210 or second 212 channel with the inlet 204 and outlet 206 orifices. As such, fluid flow between the inlet 204 and outlet 206 orifices is substantially unimpeded when the apparatus 200 is in the first state 202 (corresponding to the first channel 210 being aligned with the inlet 204 and outlet 206 orifices) and a static mixer element 214 impinges upon the fluid flow when the apparatus 200 is in the second state 202′.

It may be appreciated, then, that a pig or other object may be passed substantially unimpeded through the apparatus 200 when the apparatus 200 (and therefore the mechanism 208) is configured in the first state 202. Likewise, the apparatus 200 may be placed in the second state 202′ when it is desirable to enhance mixing, formation of dry hydrates and/or emulsions (e.g., via the static mixer element 214) in a cold-flow application, and/or the like.

While two groupings of static mixers 214 are shown in the second channel 212, any appropriate quantity and arrangement of static mixers 214 may be implemented to satisfy the design criteria of a particular application as long as the static mixers 214 do not substantially impede flow through the first channel 210.

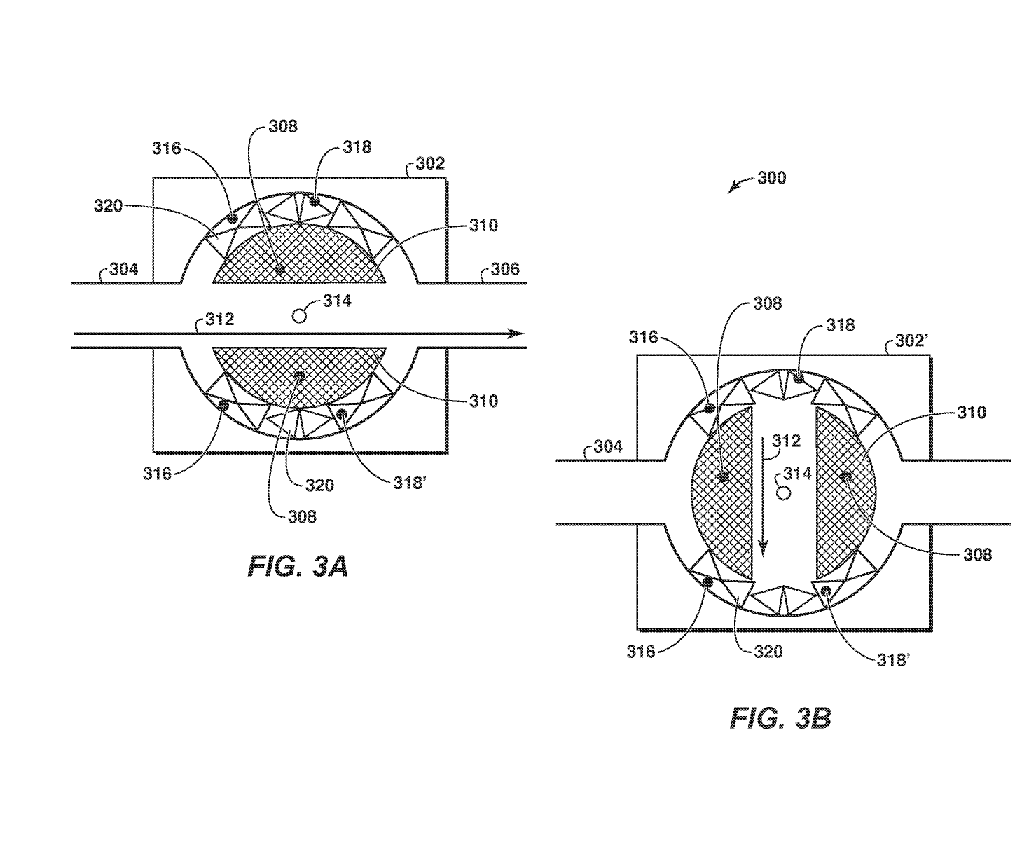

With reference to FIGS. 3A and 3B, cut-away illustrations are provided of a static mixer apparatus 300 in both a first 302 and second state 302′ in accordance with a third embodiment of the present invention. In general, the static mixer apparatus 300 comprises an inlet orifice 304 and an outlet orifice 306 in fluid communication with one another. A mechanism 308 is fluidly coupled between the inlet 304 and outlet 306 orifices. The mechanism 308 includes a diverter 310 having a channel 312 (preferably substantially devoid of obstructions) for fluidly coupling the inlet 304 and outlet 306 orifices when the mechanism 308 is in the first state 302. The mechanism 308 may rotate (clockwise and/or counterclockwise) on an axis 314 between the first 302 and second 302′ state. In general, the axis 314 is substantially perpendicular to the channel 312.

The apparatus 300 further includes a static mixer element 316 comprised of one or more groups (i.e., sets) of static mixers (e.g., 318 and 318′). In a preferred embodiment, the static mixer element 316 comprises at least two groups 318, 318′ of static mixers 320. However, any appropriate number of groups may be implemented to meet the design criteria of a particular application. Each group of one or more static mixer(s) 320 is fixedly mounted within the apparatus 300 such that the groups 318, 318′ do not rotate about axis 314. As such, fluid flow between the inlet 302 and outlet 304 orifices is substantially unimpeded when the apparatus 300 is in the first state 302 (corresponding to the channel 312 being aligned with the inlet 304 and outlet 306 orifices). In contrast, the diverter 310 directs the fluid flow around the diverter 310 and across the static mixer element 316 when the apparatus 300 is in the second state 302′. Such a design 300 may be particularly advantageous since it results in an extended length and reduced diameter through the static mixer element 316. Such characteristics of a static mixer element (e.g., 316) generally increase performance of the corresponding static mixers (e.g., 320).

It may be appreciated, then, that a pig or other object may be passed substantially unimpeded through the apparatus 300 when the apparatus 300 (and therefore the mechanism 308) is configured in the first state 302. Likewise, the apparatus 300 may be placed in the second state 302′ when it is desirable to enhance mixing, formation of dry hydrates and/or emulsions (e.g., via the static mixer element 316) in a cold-flow application, and/or the like.

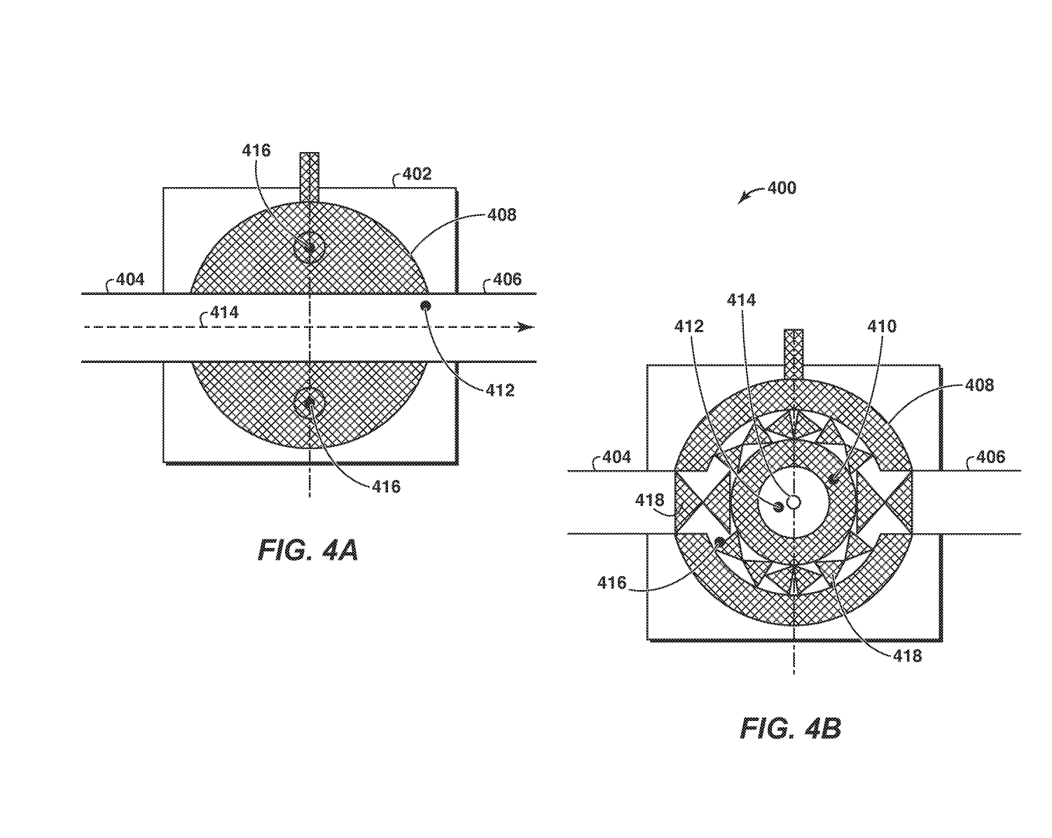

With reference to FIGS. 4A and 4B, cut-away illustrations are provided of a static mixer apparatus 400 in both a first 402 and second state 402′ in accordance with a fourth embodiment of the present invention. In general, the static mixer apparatus 400 comprises an inlet orifice 404 and an outlet orifice 406 in fluid communication with one another. A mechanism 408 is fluidly coupled between the inlet 404 and outlet 406 orifices. The mechanism 408 includes a sphere or other radially symmetrical shape such as a cylinder 410 having a center channel 412 (preferably substantially devoid of obstructions) there through. The center channel 412 is substantially coincident with a center axis 414 of the sphere 410 and configured to fluidly couple the inlet 404 and outlet 406 orifices when the mechanism 408 is in the first state 402. In at least one embodiment the sphere 410 of the mechanism 408 rotates (clockwise and/or counterclockwise) between the first 402 and second 402′ state on an axis 415. In general, the axis 415 is substantially perpendicular to the center axis 414 and, therefore, the center channel 412.

The apparatus 400 further includes a static mixer element 416 comprised of one or more static mixers 418 fixedly coupled to an outer surface 420 of the sphere 410 and along at least a portion of a cross section (e.g., a circular cross section) of the sphere 410 such that the fluid flow is diverted through the static mixer element 416 when the mechanism is in the second state 402′ and the static mixer element 416 is substantially removed from the fluid flow when the mechanism is in the first state 402. That is, flow between the inlet 402 and outlet 404 orifices is substantially unimpeded when the apparatus 400 is in the first state 402 (corresponding to the channel 412 being aligned with the inlet 404 and outlet 406 orifices) and the fluid flow is forced through the static mixer element 416 when the mechanism is in the second state 402′. Such a design 400 may be particularly advantageous since it results in an extended length and reduced diameter through the static mixer element 416. Such characteristics of a static mixer element (e.g., 416) generally increase performance of the corresponding static mixers (e.g., 418).

It may be appreciated, then, that a pig or other object may be passed substantially unimpeded through the apparatus 400 when the apparatus 400 (and therefore the mechanism 408) is configured in the first state 402. Likewise, the apparatus 400 may be placed in the second state 402′ when it is desirable to enhance mixing, formation of dry hydrates and/or emulsions (e.g., via the static mixer element 416) in a cold-flow application, and/or the like.

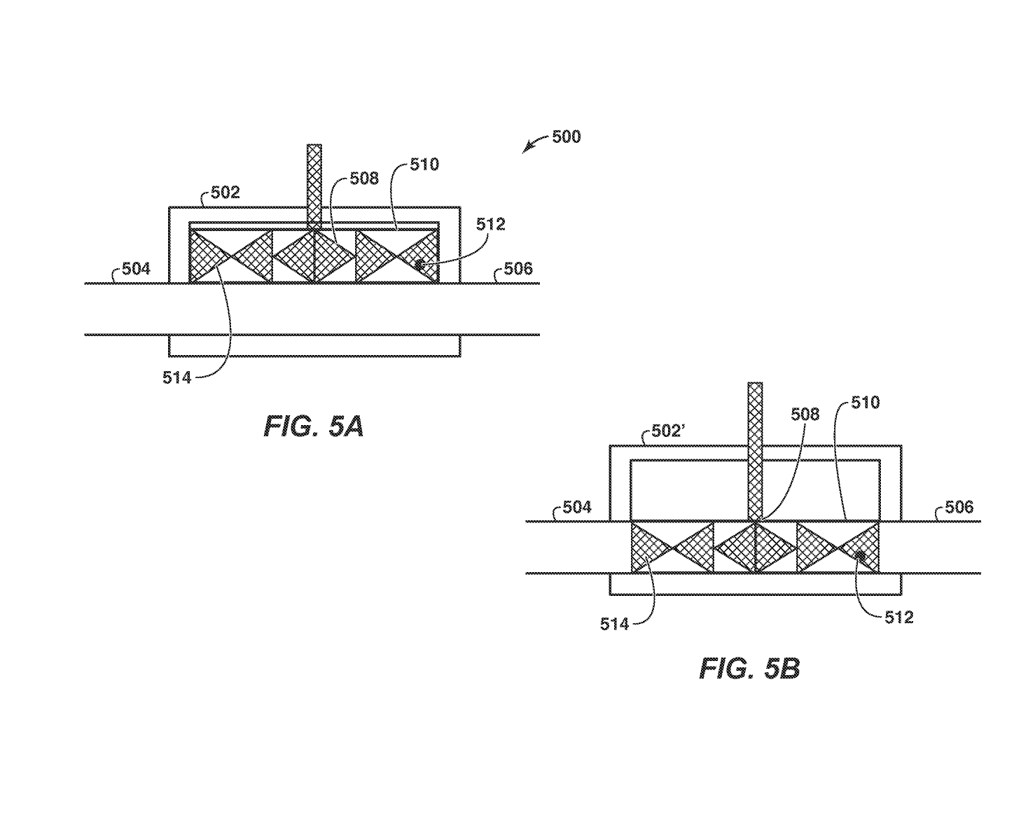

With reference to FIGS. 5A and 5B, cut-away illustrations are provided of a static mixer apparatus 500 in both a first 502 and second state 502′ in accordance with a fifth embodiment of the present invention. In general, the static mixer apparatus 500 comprises an inlet orifice 504 and an outlet orifice 506 in fluid communication with one another. A mechanism 508 is fluidly coupled between the inlet 504 and outlet 506 orifices. The mechanism 508 includes a retractable channel 510 having a static mixer element 512 therein. Any number of static mixers 514 in any appropriate grouping and/or configuration may be implemented in connection with the static mixer element 512 to meet the design criteria of a particular application.

In general, the retractable channel 510 is configured such that it is substantially extracted from fluid flow when the apparatus 500 is in the first state 502. In contrast, the channel 510 is substantially inserted into the fluid flow when the apparatus 500 is in the second state 502′. As such, the retractable channel 510 is configured to divert substantially all of the fluid flow through the static mixer element 512 when the mechanism 508 is in the second state.

It may be appreciated, then, that a pig or other object may be passed substantially unimpeded through the apparatus 500 when the apparatus 500 (and therefore the mechanism 508) is configured in the first state 502. Likewise, the apparatus 500 may be placed in the second state 502′ when it is desirable to enhance mixing, formation of dry hydrates and/or emulsions (e.g., via the static mixer element 512) in a cold-flow application, and/or the like.

The piggable static mixers provided herein are useful in systems for generating dry hydrates and reducing wax deposition. Systems including static mixers may be advantageously implemented in a subsea or arctic cold flow reactor. Exemplary systems for generating dry hydrates and/or reducing wax deposition are disclosed in U.S. Pat. Pub. No. 2009/0078406 to Talley et al. titled “Method of Generating a Non-Plugging Hydrate Slurry,” which is herein incorporated by reference. U.S. Pat. Pub. No. 2009/0078406 discloses the use of a static mixer to enhance formation of dry hydrates in a cold-flow application. While the insertion of static mixers into a pipeline may reduce the formation of undesirable wax deposits, the presence of a conventional in-line static mixer effectively eliminates the ability to pass a pig unimpeded through the pipeline. Accordingly, the piggable static mixers of the present invention are utilized.

Static mixers act to disperse water and/or gas in wellstream fluids into smaller water and/or gas droplets that are relatively quickly and completely converted into dry hydrates without, for example, the need to recycle the hydrates. Dry hydrate particles can be any size, but typically vary between about 1 and about 30 microns in diameter. Without being limited by theory, it is believed that the static mixers disturb the generally normal laminar type flow that would otherwise permit wax deposition on the pipe walls, and create turbulent flow that retains formed wax particles in the flowing fluid.

Systems for selectively impinging a static mixer element as described herein upon a fluid flow include static mixer configurations where: (a) one or more static mixers 550 are located in a main pipeline 551, such as shown in FIG. 6A, (b) one or more static mixers 550 are located in a side stream 552, i.e., reactor or cold-flow reactor, which is in fluid communication with a main pipeline 551, (c) one or more static mixers 550 are located in two or more side streams 552, i.e., primary reactor, secondary reactor, etc., which are each in fluid communication with a main pipeline 551, and which may be in fluid communication with each other, (d) one or more static mixers 550 are located in a main pipeline 551 and one or more static mixers 550 are located in a side stream 552, which is in fluid communication with a main pipeline 551, or (e) one or more static mixers 550 are located in a main pipeline 551 and one or more static mixers 550 are located in two or more side streams 552, which are each in fluid communication with a main pipeline 551, and which may be in fluid communication with each other. FIG. 6B shows an exemplary embodiment of configuration (c).

In systems having two or more side streams, the side streams can be the same size or different sizes. The two or more side streams are each be independently located anywhere along the main pipeline.

In one or more embodiments of configuration (c), an outlet of the primary reactor may be in direct fluid communication with an inlet of the secondary reactor. Both primary and secondary reactors may have an inlet in fluid communication with the main pipeline. Similarly, both the primary and secondary reactors may have an outlet in fluid communication with the main pipeline. Alternatively, the secondary reactor may have an inlet in fluid communication with the first reactor, but no inlet in fluid communication with the main pipeline.

In embodiments where static mixers are in a sidestream, any amount of the well stream may be introduced to the side stream, such as less than 30% by volume of the full well stream. Preferably, no more than 5% by volume of the wellstream is introduced to the sidestream. Alternatively, no more than 1% by volume of the wellstream is introduced to the sidestream.

The side stream may be in the shape of a small diameter pipe. In a vertical configuration, the sidestream may comprise alternating upward and downward flowing pipes, i.e., S-pattern. Static mixers may be installed in the upward flowing pipes, downward flowing pipes, or both upward and downward flowing pipes.

In one or more embodiments, the sidestream includes a gas-fluid connection to a gas tank to allow a gas phase in the wellstream to be separated from the liquid phase of the wellstream.

In one or more embodiments, the sidestream includes a falling film reactor. The diverted portion of wellstream may be injected into the sidestream along the walls of the reactor. The method further contemplates injecting water and high pressure gas into the falling film reactor to form a dry hydrate along the walls of the reactor. The injected water and gas may be separated from the dry hydrate sidestream slurry before the slurry is fed into the main pipeline. At least one static mixer may be installed in the section of the main pipeline after a point where the dry hydrate sidestream is fed into the main pipeline.

Also provided are methods for producing hydrocarbons using any of the systems described above for transporting hydrocarbons once the hydrocarbons are produced from the wellhead. The hydrocarbons are preferably greater than 50% of the total liquid volume. Gas phase hydrocarbons are preferably less than 50% of the total pipe volume.

In still further embodiments, provided are methods of producing dry hydrates, which include the steps of: (a) passing a hydrocarbon stream comprising water and one or more hydrate-forming gases through a cold-flow reactor, said cold-flow reactor having one or more static mixers disposed therein; (b) reducing the droplet size of said water in said hydrocarbon stream by passing said hydrocarbon stream through said one or more static mixers; and (c) converting at least a portion of said water into dry hydrates.

Also provided are methods of avoiding wax deposition and rendering a pumpable fluid of liquid hydrocarbon and wax components, which include the steps of conveying the fluid through a pipe connected to a reactor comprising a static mixer and through the reactor before and while the fluid temperature drops below the wax appearance temperature. The fluids are mixed by their action in the area of the static mixer(s), resulting in fine wax solids that are conveyed with the fluid rather than coated/deposited on the pipe wall. The fluids are then conveyed to a processing facility without materially increasing the fluid viscosity.

In one or more embodiments, a heat exchanger may be used, for example near a wellhead or other source of fluid, so as to define the wax precipitation pressure/temperature regime near such wellhead or source. Thus, one or more static mixer(s) can be positioned in the region to force wax particle formation and avoid deposition on pipeline walls. Further the produced stream could be subjected to the static mixer(s) in the region within about a kilometer, or one-half kilometer, or one-third kilometer of the source, usually about five minutes or seven minutes, or ten minutes of flow time and distance. This can be used for production or distribution pipelines and has great applicability to both subsea and arctic environments.

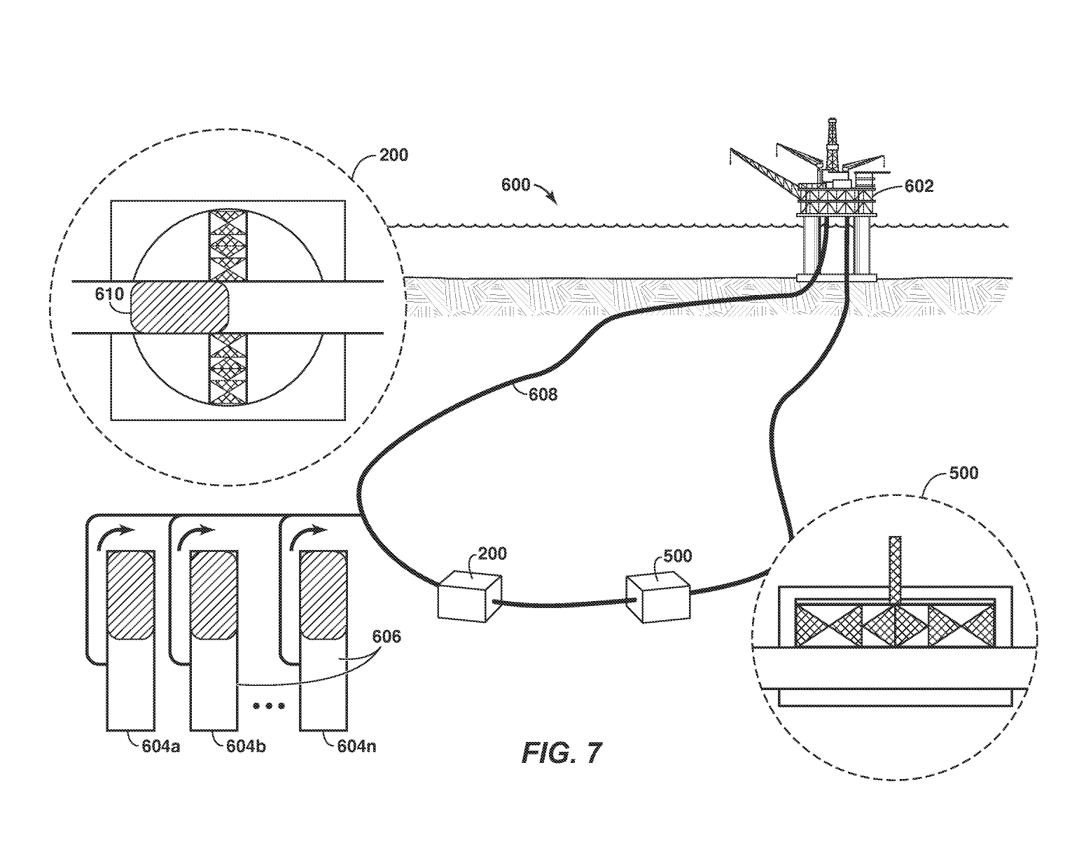

With reference to FIG. 7, an exemplary system 600 is provided for generating and recovering subsea dry hydrates using static mixers in accordance with embodiments of the present invention. The system 600 may include a production facility 602, one or more subsea production well(s) 604 feeding wellstream fluid 606 into a production line 608 and/or one or more static mixer apparatuses in accordance with one or more embodiments of the present invention (e.g., static mixer apparatuses 200, 500).

System 600 is an exemplary system in which one or more embodiments of the present invention may be advantageously implemented. More specifically, implementation of one or more embodiments of the present invention may facilitate the pigging (e.g., using pig 610) of the production line 608 without the need to implement bypass sections around the static mixers.

### EMBODIMENTS

Further embodiments of the present invention are provided below in embodiments A-JJ.

### Embodiment A

A static mixer apparatus, comprising:

an inlet orifice,

an outlet orifice in fluid communication with the inlet orifice, and

a mechanism fluidly coupled between the inlet and outlet orifices, the mechanism configurable between a first state and a second state, wherein fluid flow between the inlet and outlet orifices is substantially unimpeded when the mechanism is in the first state and a static mixer element impinges upon the fluid flow when the mechanism is in the second state.

### Embodiment B

The apparatus of embodiment A, wherein the static mixer element comprises a plurality of groups of static mixers.

### Embodiment C

The apparatus of embodiment A or B, wherein:

the mechanism comprises a retractable plate;

the static mixer element comprises a plurality of holes in the retractable plate;

the retractable plate is extracted from the fluid flow in the first state; and

the retractable plate is inserted into the fluid flow in the second state.

### Embodiment D

The apparatus of embodiment C, wherein each hole of the static mixer element includes a static mixer.

### Embodiment E

The apparatus of embodiment A or B, wherein the mechanism comprises:

a first channel substantially devoid of obstructions for fluidly coupling the inlet and outlet orifices when the mechanism is in the first state; and

a second channel including the static mixer element for fluidly coupling the static mixer element between the inlet and outlet orifices when the mechanism is in the second state.

### Embodiment F

The apparatus of embodiment E, wherein the mechanism rotates on an axis between the first state and the second state.

### Embodiment G

The apparatus of embodiment A or B, wherein:

the mechanism includes a diverter having a channel substantially devoid of obstructions for fluidly coupling the inlet and outlet orifices when the mechanism is in the first state; and

the diverter directs the fluid flow around the diverter and across the static mixer element when the mechanism is in the second state.

### Embodiment H

The apparatus of embodiment G, wherein the diverter rotates about an axis and the axis is substantially perpendicular to the channel.

### Embodiment I

The apparatus of embodiment A or B, wherein the mechanism comprises a radially symmetrical shape having a center channel there through, the center channel substantially coincident with a center axis of the radially symmetrical shape and configured to fluidly couple the inlet and outlet orifices when the mechanism is in the first state.

### Embodiment J

The apparatus of embodiment I, wherein the center channel is substantially devoid of obstructions.

### Embodiment K

The apparatus of embodiment I or J, wherein the radially symmetrical shape rotates about an axis substantially perpendicular to the center axis.

### Embodiment L

The apparatus of embodiment K, wherein the static mixer element comprises one or more static mixers fixedly coupled to an outer surface of the radially symmetrical shape and along at least a portion of a cross section of the radially symmetrical shape such that the fluid flow is diverted through the static mixer element when the mechanism is in the second state and the static mixer element is substantially removed from the fluid flow when the mechanism is in the first state.

### Embodiment M

The apparatus of embodiment A or B, wherein:

the mechanism comprises a retractable channel,

the static mixer element is located in the retractable channel;

the retractable channel is extracted from the fluid flow in the first state; and

the retractable channel is inserted into the fluid flow in the second state.

### Embodiment N

The apparatus of embodiment M, wherein the retractable channel is configured to divert substantially all of the fluid flow through the static mixer element when the mechanism is in the second state.

### Embodiment O

The apparatus of any of embodiments A-N, wherein the mechanism is configured to pass a pig substantially unimpeded between the inlet and outlet orifices when the mechanism is in the first state.

### Embodiment P

The apparatus of embodiment O, wherein the pig is configured to remove buildup from a section of pipe in fluid communication with the apparatus.

### Embodiment Q

The apparatus of embodiment P, wherein the buildup is wax, scale, or a combination thereof.

### Embodiment R

The apparatus of embodiment P, wherein the buildup is a byproduct of a cold-flow process implemented in connection with a system for transporting a flow of wellstream hydrocarbons.

### Embodiment S

The apparatus of any of embodiments O-R, wherein the pig is configured to provide chemical dosing in a section of pipe in fluid communication with the mechanism.

### Embodiment T

The apparatus of any of embodiments O-S, wherein the pig is configured to provide corrosion surveillance in a section of pipe in fluid communication with the mechanism.

### Embodiment U

A system for selectively impinging a static mixer element upon a fluid flow:

a production facility;

a production line; and
a static mixer apparatus fluidly coupled in-line with the production line wherein the static mixer apparatus includes:
an inlet orifice;
an outlet orifice in fluid communication with the inlet orifice; and
a mechanism fluidly coupled between the inlet and outlet orifices, the mechanism configurable between a first state and a second state, wherein fluid flow between the inlet and outlet orifices is substantially unimpeded when the mechanism is in the first state and a static mixer element impinges upon the fluid flow when the mechanism is in the second state.

### Embodiment V

A system for generating a hydrate slurry comprising:

a main pipeline,

one or more static mixer apparatus of any of embodiments A-T,

wherein the one or more static mixer apparatus are located in the main pipeline and are fluidly coupled in-line with the main pipeline.

### Embodiment W

A system for generating a hydrate slurry comprising:

a main pipeline,

a sidestream, which is in fluid communication with the main pipeline,

one or more static mixer apparatus of any of embodiments A-T,

wherein the one or more static mixer apparatus are located in the sidestream and are fluidly coupled in-line with the sidestream.

### Embodiment X

A system for generating a hydrate slurry comprising:

a main pipeline,

two or more sidestreams, which are each in fluid communication with the main pipeline,

one or more static mixer apparatus of any of embodiments A-T,

wherein the one or more static mixer apparatus are locate in the two or more sidestreams and are fluidly coupled in-line with the two or more sidestreams.

### Embodiment Y

The system of embodiment X, wherein the two or more sidestreams are in direct fluid communication with each other.

### Embodiment Z

The system of any of embodiments W-Y, further comprising one or more static mixer apparatus located in the main pipeline.

### Embodiment AA

The system of any of embodiments W-Z, wherein the one or more sidestreams comprise a pipe with roughened walls.

### Embodiment BB

The system of any of embodiments U-AA, wherein the one or more static mixers are substantially free of energized equipment.

### Embodiment CC

The system of any of embodiments U-BB, further comprising an injection umbilical connected to a production facility above sea level.

### Embodiment DD

The system of any of embodiments U-CC, wherein the mechanism is configured to pass a pig substantially unimpeded between the inlet and outlet orifices when the mechanism is in the first state.

### Embodiment EE

The system of embodiment DD, wherein the pig is configured to remove buildup from the production line.

### Embodiment FF

The system of embodiment EE, wherein the buildup is wax, scale or a combination of wax and scale.

### Embodiment GG

The system of any of embodiments DD-FF, wherein the pig is configured to provide chemical dosing in the production line.

### Embodiment HH

The system of any of embodiments DD-GG, wherein the pig is configured to provide corrosion surveillance of the production line.

### Embodiment II

The system of any of embodiments U-HH, further comprising one or more heat exchangers.

### Embodiment JJ

A method for producing hydrocarbons from a wellstream comprising the steps of:

(a) transporting a flow of wellstream hydrocarbons to a system of any of embodiments U-II,

(b) forming a hydrate slurry with the system,

(c) transporting the hydrate slurry to a production facility.

The exemplary embodiments discussed above have been shown by way of example. However, it should again be understood that the inventions provided herein are not intended to be limited to a particular embodiment disclosed herein. Indeed, the present inventions cover all modifications, equivalents, and alternatives falling within the spirit and scope of the invention as defined by the following appended claims.

What is claimed is:

1. A static mixer apparatus, comprising:
an inlet orifice;
an outlet orifice in fluid communication with the inlet orifice; and
a mechanism fluidly coupled between the inlet and outlet orifices, the mechanism configurable between a first state and a second state, wherein fluid flow between the inlet and outlet orifices is substantially unimpeded when the mechanism is in the first state and a static mixer element impinges upon the fluid flow when the mechanism is in the second state.

2. The apparatus of claim 1 wherein the static mixer element comprises a plurality of groups of static mixers.

3. The apparatus of claim 1, wherein:
the mechanism comprises a retractable plate;
the static mixer element comprises a plurality of holes in the retractable plate;
the retractable plate is extracted from the fluid flow in the first state; and
the retractable plate is inserted into the fluid flow in the second state.

4. The apparatus of claim 3 wherein each hole of the static mixer element includes a static mixer.

5. The apparatus of claim 1, wherein the mechanism comprises:
a first channel substantially devoid of obstructions for fluidly coupling the inlet and outlet orifices when the mechanism is in the first state; and
a second channel including the static mixer element for fluidly coupling the static mixer element between the inlet and outlet orifices when the mechanism is in the second state.

6. The apparatus of claim 5 wherein the mechanism rotates on an axis between the first state and the second state.

7. The apparatus of claim 1 wherein:
the mechanism includes a diverter having a channel substantially devoid of obstructions for fluidly coupling the inlet and outlet orifices when the mechanism is in the first state; and
the diverter directs the fluid flow around the diverter and across the static mixer element when the mechanism is in the second state.

8. The apparatus of claim 7 wherein the diverter rotates about an axis and the axis is substantially perpendicular to the channel.

9. The apparatus of claim 7 wherein the static mixer element comprises a plurality of groups of static mixers.

10. The apparatus of claim 1 wherein the mechanism comprises a radially symmetrical shape having a center channel there through, the center channel substantially coincident with a center axis of the radially symmetrical shape and configured to fluidly couple the inlet and outlet orifices when the mechanism is in the first state.

11. The apparatus of claim 10 wherein the center channel is substantially devoid of obstructions.

12. The apparatus of claim 11 wherein the radially symmetrical shape rotates about an axis substantially perpendicular to the center axis.

13. The apparatus of claim 12 wherein the static mixer element comprises one or more static mixers fixedly coupled to an outer surface of the radially symmetrical shape and along at least a portion of a cross section of the radially symmetrical shape such that the fluid flow is diverted through the static mixer element when the mechanism is in the second state and the static mixer element is substantially removed from the fluid flow when the mechanism is in the first state.

14. The apparatus of claim 1, wherein:
the mechanism comprises a retractable channel,
the static mixer element is located in the retractable channel;
the retractable channel is extracted from the fluid flow in the first state; and
the retractable channel is inserted into the fluid flow in the second state.

15. The apparatus of claim 14 wherein the retractable channel is configured to divert substantially all of the fluid flow through the static mixer element when the mechanism is in the second state.

16. The apparatus of claim 1 wherein the mechanism is configured to pass a pig substantially unimpeded between the inlet and outlet orifices when the mechanism is in the first state.

17. The apparatus of claim 16 wherein the pig is configured to remove buildup from a section of pipe in fluid communication with the apparatus.

18. The apparatus of claim 17 wherein the buildup is wax, scale or a combination of wax and scale.

19. The apparatus of claim 17 wherein the buildup is a byproduct of a cold-flow process implemented in connection with a system for transporting a flow of wellstream hydrocarbons.

20. The apparatus of claim 16 wherein the pig is configured to provide chemical dosing in a section of pipe in fluid communication with the mechanism.

21. The apparatus of claim 16 wherein the pig is configured to provide corrosion surveillance in a section of pipe in fluid communication with the mechanism.

22. A system for selectively impinging a static mixer element upon a fluid flow:
a production facility;
a production line; and
a static mixer apparatus fluidly coupled in-line with the production line wherein the static mixer apparatus includes:
an inlet orifice;
an outlet orifice in fluid communication with the inlet orifice; and
a mechanism fluidly coupled between the inlet and outlet orifices, the mechanism configurable between a first state and a second state, wherein fluid flow between the inlet and outlet orifices is substantially unimpeded when the mechanism is in the first state and a static mixer element impinges upon the fluid flow when the mechanism is in the second state.

23. A system for generating a nonplugging hydrate slurry comprising:
a main pipeline,
one or more static mixer apparatus of any of embodiments A-T,
wherein the one or more static mixer apparatus are located in the main pipeline and are fluidly coupled in-line with the main pipeline.

24. A system for generating a nonplugging hydrate slurry comprising:
a main pipeline,
a sidestream, which is in fluid communication with the main pipeline,
one or more static mixer apparatus each comprising:
an inlet,
an outlet, in fluid communication with the inlet, and
a mechanism fluidly coupled between the inlet and outlet, which is configurable between a first state and a second state, wherein fluid flow between the inlet and outlet orifices is substantially unimpeded when the mechanism is in the first state and a static mixer element impinges upon the fluid flow when the mechanism is in the second state,
wherein the one or more static mixer apparatus are located in the sidestream and are fluidly coupled in-line with the sidestream.

25. A system for generating a nonplugging hydrate slurry comprising:
a main pipeline,
two or more sidestreams, which are each in fluid communication with the main pipeline,
one or more static mixer apparatus each comprising:
an inlet,
an outlet, in fluid communication with the inlet, and
a mechanism fluidly coupled between the inlet and outlet, which is configurable between a first state and a second state, wherein fluid flow between the inlet and outlet orifices is substantially unimpeded when the mechanism is in the first state and a static mixer element impinges upon the fluid flow when the mechanism is in the second state,
wherein the one or more static mixer apparatus are locate in the two or more sidestreams and are fluidly coupled in-line with the two or more sidestreams.

26. The system of claim 22 wherein the mechanism is configured to pass a pig substantially unimpeded between the inlet and outlet orifices when the mechanism is in the first state.

27. The system of claim 26 wherein the pig is configured to remove wax, scale, or combinations thereof from the production line.

28. The system of claim 26 wherein the pig is configured to provide chemical dosing in the production line.

29. The system of claim 26 wherein the pig is configured to provide corrosion surveillance of the production line.

30. The system of claim 22, further comprising one or more heat exchangers.

31. A method for producing hydrocarbons from a wellstream comprising the steps of:
(a) transporting a flow of wellstream hydrocarbons to a system for generating a hydrate slurry comprising:
a main pipeline,
one or more sidestreams, which are each in fluid communication with the main pipeline,
one or more static mixer apparatus each comprising:
an inlet,
an outlet, in fluid communication with the inlet, and
a mechanism fluidly coupled between the inlet and outlet, which is configurable between a first state and a second state, wherein fluid flow between the inlet and outlet orifices is substantially unimpeded when the mechanism is in the first state and a static mixer element impinges upon the fluid flow when the mechanism is in the second state,
wherein the one or more static mixer apparatus are locate in the one or more sidestreams and are fluidly coupled in-line with the one or more sidestreams,
(b) forming a hydrate slurry with the system,
(c) transporting the hydrate slurry to a production facility.
